(19) United States
(12) Patent Application Publication
(10) Pub. No.: US 2008/0269457 A1
(43) Pub. Date: Oct. 30, 2008

(54) Process For Producing Polyimide Fine Particle

(75) Inventor: Hiroshi Samukawa, Tochigi (JP)

Correspondence Address: OLIFF & BERRIDGE, PLC, P.O. BOX 320850, ALEXANDRIA, VA, 22320-4850, US

(73) Assignee: Sony Chemical & Information Device Corporation, Tokyo (JP)

(21) Appl. No.: 11/886,063

(22) PCT Filed: Apr. 11, 2006
(86) PCT No.: PCT/JP2006/307630

§ 371 Date: Sep. 11, 2007

(51) Int. Cl. C08G 69/28; C08G 69/26

(52) U.S. Cl. 528/336; 528/335

(57) ABSTRACT

A process for producing polyimide fine particles that involves subjecting a polyamic acid solution to a thermal imidization process to directly produce polyimide fine particles. In the process, relatively monodisperse, non-aggregating fine polyimide particles can be directly obtained without using thermal imidization catalysts that are difficult to remove from the reaction mixture or without using an azeotropic solvent to remove the water produced.

Specifically, the process for producing polyimide fine particles comprises the step of subjecting a polyamic acid solution to a thermal imidization process to crystallize polyimide as fine particles. The thermal imidization step comprises heating the polyamic acid solution while the solution is irradiated with ultrasound.

### TECHNICAL FIELD

The present invention relates to a process for polyimide fine particles that can be used as a material for polyimide molded articles or as a heat-resistant filler.

### BACKGROUND ART

Polyimides have various advantageous properties including heat resistance, insulating property, solvent resistance, and low-temperature resistance and are therefore widely used as a material to make parts for semiconductor devices and electric and electronic devices. Polyimides are used in a variety of forms, including polyimide films, polyimide insulative varnishes, polyimide photosensitive coatings, polyimide electrodeposition coatings, polyimide adhesives, polyimide powders/fine particles, polyimide molded articles, and various other forms. Of the different forms of polyimides, polyimide powders/fine particles sized several microns or smaller can be used as heat-resistant fillers in various articles with fine structures and are increasingly needed.

An early application of polyimide powders/fine particles involved compacting polyimide powders at high temperatures to make polyimide molded articles. Powders used for this purpose were produced by a known technique. Specifically, a tetracarboxylic dianhydride is reacted with a diamine in an organic solvent to make a polyamic acid solution, which is added to a poor solvent and the precipitated solid product is imidized by heating. The imidized product is then mechanically pulverized into powder. It was difficult, however, to obtain uniform fine polyimide particles by mechanical pulverization.

To obtain fine powder polyimide materials more suitable for making molded articles, several techniques have been proposed. In one such technique, a polyamic acid, the polymer precursor of polyimide, is chemically imidized in a solution and the resulting polyimide is precipitated. Alternatively, polyamic acid may first be precipitated by adding a poor solvent to the polyamic acid solution and the precipitated product is chemically imidized (Patent Document 1). In another technique, a tertially amine, such as pyridine, is used as an imidization catalyst and polyamic acid is thermally imidized using the catalyst at 100° C. to 200° C. In this manner, hydrolysis and other unwanted side reactions can be prevented and, as a result, fine polyimide particles can be obtained (Patent Document 2).

However, the fine particles obtained by these techniques vary in size depending on a particular combination of tetracarboxylic dianhydride and diamine used. In some cases, the particles larger than 10 μm in size may result and in other cases, particles form aggregates by fusing.

Recently, attempts have been made to use polyimide fine particles as a heat-resistant filler. For example, the possibility is suggested of using polyimide fine particles as a filler for polyamic varnishes and soluble polyimide varnishes. The filler is intended to decrease the viscosity and the contraction of the polyimides. Not only are the polyimide fine particles for this application required to have a particle size of several microns or less, but they are also required to be relatively monodisperse, highly dispersible, and not strongly aggregated. The techniques described in Patent Documents 1 and 2 cannot achieve fine particles that meet these requirements. Thus, there is a need for a technique that can produce polyimide fine particles that are sized several microns or less, are monodispersive, and are non-aggregating.

One such process has been proposed and involves the following three steps. In the first step, a solution of a tetracarboxylic dianhydride and a solution of a diamine are separately prepared. In the second step, the two solutions are mixed together and the reaction is allowed to proceed while the reaction mixture is irradiated with ultrasound. Polyamic acid, the reaction product, crystallizes as fine particles. In the third step, the polyamic acid fine particles are subjected to a heat treatment for imidization (Patent Document 3). Though this process can afford monodisperse polyimide particles, it is hindered by the limitation that the concentration of the reaction mixture cannot be increased above a certain level. The process therefore requires large volumes of solvents and is less attractive in view of increasing environmental concern requiring the use of less solvents. The third step of the process for imidization of the polyamic acid particles also requires solvents, making the overall process even more complicated. In short, the process can afford only small amounts of polyimide particles despite the large volumes of solvents used and fails to provide inexpensive polyimide particles.

To circumvent the drawbacks of this process, one approach attempts to directly obtain polyimide fine particles, rather than indirectly obtaining them from fine particles of polyamic acid. In this process, a polyamic acid solution containing a relatively high concentration of polyamic acid is heated to thermally imidize the polyamic acid in the solution. The resulting polyimide is precipitated while the degree of crystallinity is controlled to 50% or higher (Non-Patent Document 1 and Patent Document 4). With the degree of crystallinity being controlled to 50% or higher, the particles obtained by this process are substantially identical in shape to those obtained by the processes described in Patent Documents 1 and 2. Thus, it is difficult to produce monodisperse, non-aggregating fine particles. The size and shape of the polyimide particles depend on a particular combination of acid dianhydride and diamine and the type of solvents used, making it difficult to make monodisperse particles of a desired size. The process tends to result in the formation of large particles sized 10 μm or larger. This tendency becomes stronger as the concentration of polyamic acid is increased or the reaction temperature is increased in an attempt to increase the production efficiency. There has thus been no process that enables production of 10 μm or larger polyimide particles without first producing intermediate particles of polyamic acid. Polyimide particles 10 μm or larger in size are too large to be used as a filler and a technique is therefore needed that can readily produce 10 μm or smaller polyimide particles.

Another problem associated with the conventional thermal imidization techniques is that water produced during the thermal imidization mixes with the solvents and causes hydrolysis of unreacted polyamic acid, thus resulting in a decreased molecular weight of the resulting polyimide. To counteract this problem, an azeotropic solvent, such as toluene, that can form an azeotrope with water is added to eliminate water from the reaction system. However, toluene is highly inflammable and must be separated by using a special oil separation technique. This makes the process more complicated. Furthermore, the oil separator adds to the production cost. Another approach is carrying out the imidization process at as low a temperature as possible to keep the rate of hydrolysis low while adding a catalyst that facilitates the imidization process. Although pyridines or tertially amines are typically used as the catalyst, these compounds are harmful to health and environment and removing them from the reaction products requires complicated processes.

| | |
|---|---|
| Patent Document 1 | U.S. Pat. No. 3,179,631 |
| Patent Document 2 | U.S. Pat. No. 3,249,588 |
| Patent Document 3 | Japanese Patent Application Laid- |
| | Open No. Hei 11-140181 |
| Non-Patent | Yasuhisa Nagata, Japanese Journal |
| Document 1 | of Polymer Science and Technology, |
| | 53, 63 (1996) |
| Patent Document 4 | Japanese Patent No. 2950489 |

### DISCLOSURE OF THE INVENTION

### Problems to be Solved by the Invention

As described above, the thermal imidization of polyamic acid solutions is an economical approach that makes it possible to directly obtain polyimide fine particles without the need to isolate polyamic acid fine particles. The technique however results in the formation of relatively large polyimide particles that have a tendency to aggregate, so that it cannot be used to make monodisperse fine particles with a smaller particle size. In addition, the thermal imidization catalysts used in the process are difficult to remove. Moreover, water must be removed by using azeotropic solvents.

It is an object of the present invention to improve the thermal imidization process of polyamic acid solutions, so that relatively monodisperse, non-aggregating fine polyimide particles can be directly obtained without using thermal imidization catalysts that are difficult to remove from the reaction mixture or without using azeotropic solvents to remove the water produced.

### Means to Solve the Problems

Conventionally, polyamic acid fine particles were produced by mixing a solution of tetracarboxylic dianhydride with a diamine solution and this process involved sonicating the reaction mixture to make finer particles. The present inventors found that sonicating the polyamic acid solution while it is subjected to the thermal imidization process makes it possible to obtain monodisperse fine polyimide particles. It is this discovery that led to the present invention.

Specifically, the present invention provides a process for producing polyimide fine particles, comprising the step of subjecting a polyamic acid solution to a thermal imidization process to crystallize polyimide as fine particles, wherein the thermal imidization step comprises heating the polyamic acid solution while the solution is irradiated with ultrasound.

In the production method of polyimide particles, the thermal imidization is preferably carried out by heating the polyamic acid solution to 180° C. or above. More preferably, the polyamic acid solution is heated under a stream of nitrogen to a temperature that is 180° C. or above and near the boiling point of the solvent used to make the solution.

In the production method of polyimide particles of the present invention, particles of a nucleating agent and/or an energy-transfer agent are preferably dispersed in the polyamic acid solution prior to the thermal imidization.

The polyamic acid solution is preferably obtained by reacting a carboxylic acid dianhydride with a diamine in a solvent.

### ADVANTAGES OF THE INVENTION

Conventionally, polyimide fine particles were directly obtained from a polyamic acid solution by thermally imidizing the polyamic acid solution. In the process of the present invention, the thermal imidization is carried out while the polyamic acid solution is irradiated with ultrasound. This enables the production of relatively uniform polyimide fine particles with a narrow size distribution. The thermal imidization of polyamic acid proceeds smoothly when the polyamic acid solution is heated to 180° C. or above. In addition, when the polyamic acid solution is heated under a stream of nitrogen to a temperature near the boiling point of the solvent used to make the polyamic acid solution, the solution keeps boiling as the solvent steadily evaporates forming small bubbles. The ascending small bubbles help maintain the vigorous convection flow of the entire reaction mixture, so that water produced during the imidization is eliminated from the system along with the nitrogen gas. As a result, hydrolysis, a side reaction, is prevented despite the high temperature of the reaction system, allowing effective production of polyimide particles. Thus, polyimide fine particles can be obtained without using thermal imidization catalysts that are difficult to remove from the reaction mixture or azeotropic solvents to remove the water produced.

The crystallization of polyimide particles during the process of the present invention can be facilitated by dispersing sub-micron particles of a nucleating agent in the polyamic acid solution prior to thermal imidization. The nucleating agent provides a surface on which polyimide crystallizes, thus facilitating the formation of uniform polyimide particles. Fine particles of a polyimide nucleating agent may also be used to improve adhesion between the nucleating agent and the polyimide crystallized on the surface of the nucleating agent. Furthermore, particles of an energy-transferring agent may be dispersed in the polyamic acid solution to promote the energy transfer from ultrasound to polyimide. This facilitates the formation of finer polyimide particles with a narrow size distribution.

Polyamic acid solutions prepared by reacting a carboxylic acid dianhydride with a diamine in a solvent can be directly used in the production of polyimide particles without the need to isolate polyamic acid. The use of such solutions simplifies the entire process.

### BRIEF DESCRIPTION OF THE DRAWINGS

FIG. 1A is a schematic view of a rod-shaped particle.

FIG. 1B is a schematic view of a symmetric fan-shaped particle.

FIG. 1C is a schematic view of a planar circular particle.

FIG. 1D is a schematic view of a globular particle.

FIG. 2 is a schematic view of an experimental setup of a thermal imidization reactor.

FIG. 3A is an electron micrograph of polyimide fine particles of Example 1.

FIG. 3B is an electron micrograph of polyimide fine particles of Example 1.

FIG. 4A is an electron micrograph of polyimide fine particles of Comparative Example 1.

FIG. 4B is an electron micrograph of polyimide fine particles of Comparative Example 1.

FIG. 5 is an electron micrograph of polyimide fine particles of Example 5.

FIG. 6 is an electron micrograph of polyimide fine particles of Comparative Example 5.

FIG. 7 is an electron micrograph of polyimide fine particles of Example 6.

FIG. 8 is an electron micrograph of polyimide fine particles of Comparative Example 6.

FIG. 9 is an electron micrograph of polyimide fine particles of Example 7.

FIG. 10A is an electron micrograph of polyimide fine particles of Comparative Example 7.

FIG. 10B is an electron micrograph of polyimide fine particles of Comparative Example 7.

FIG. 11 is an electron micrograph of polyimide fine particles of Example 8.

FIG. 12 is an electron micrograph of polyimide fine particles of Example 9.

FIG. 13 is an electron micrograph of polyimide fine particles of Example 10.

FIG. 14 is an electron micrograph of polyimide fine particles of Example 11.

FIG. 15 is an electron micrograph of polyimide fine particles of Example 12.

FIG. 16A is an electron micrograph of polyimide fine particles of Example 13.

FIG. 16B is an electron micrograph of polyimide fine particles of Example 13.

### DESCRIPTION OF REFERENCE NUMERALS

1. Glass reaction vessel
2. Reaction mixture
3. Stirrer
4. Magnetic stirrer
5. Oil bath
6. Oil
7. Thermometer
8. Cooling tube
9. Nitrogen outlet
10. Nitrogen inlet
11. Thermocouple
12. Thermometer
13. Ultrasound oscillator main unit
14. Converter
15. Cooling air inlet
16. Cooling air outlet
17. Probe

### BEST MODE FOR CARRYING OUT THE INVENTION

The present invention concerns a process for producing polyimide fine particles in which a polyamic acid solution is subjected to a thermal imidization process and polyimide fine particles are crystallized from the processed solution. The process of the present invention is unique in that the thermal imidization process involves heating the polyamic acid solution while the solution is irradiated with ultrasound.

We first describe the polyamic acid solution for use in the process of the present invention.

### Preparation of Polyamic Acid Solution.

A polyamic acid solution for use in the present invention includes a polyamic acid, the polymer precursor of polyimide fine particles of the present invention, and a solvent for dissolving the polyamic acid. The polyamic solution may be prepared by dissolving an isolated polyamic acid in the solvent, or it may be prepared through a conventional polyaddition reaction involving a tetracarboxylic dianhydride and a diamine that is carried out under a particular condition to prevent the precipitation of the resulting polyamic acid. Specifically, the polyamic acid solution can be prepared by simply dissolving a tetracarboxylic dianhydride and a diamine in an aprotic polar solvent and rotating a glass vial containing the solution in a jar mill or a similar apparatus for several hours. The preparation of the polyamic acid solution does not require a special reactor, nor does it require controlling the reaction temperature as long as the reaction system is designed to ensure the smooth polyaddition reaction. For example, the polyamic acid solution can be obtained by starting the reaction at room temperature, allowing the reaction temperature to spontaneously rise as the reaction heat is generated, and allowing the reaction system to cool back down to room temperature upon completion of the reaction. In the reaction systems in which polyaddition reaction proceeds slowly, the reaction may be carried out in the same manner using a common reactor or a hot jar mill at a temperature of 40° C. to 100° C.

The solvent used to make the polyamic acid solution is preferably a liquid medium suitable for the subsequent thermal imidization process since it is cost-effective if the solvent does not require replacement and can be used throughout the process from the preparation of the polyamic acid solution to the subsequent thermal imidization.

Such a solvent needs to be a good solvent of polyamic acid and at the same time a poor solvent of polyimide product while having a boiling point equal to or above the thermal imidization temperature. Since the thermal imidization is typically carried out at a temperature of 150° C. or above, and preferably at 180° C. or above, the solvent for use in the process of the present invention may be an aprotic polar solvent that has a 150° C. or higher boiling point. Preferred examples of such solvents include nitrogen-based solvents, such as N,N-dimethylformamide (bp=153° C.), N,N-diethylformamide (bp=177° C.), N,N-dimethylacetamide (bp=166° C.), N,N-diethylacetamide (bp=184° C.), N-methylpyrrolidone (bp=202° C.), ε-caprolactam (bp=189° C.), and the like; and sulfur-based solvents, such as dimethylsulfoxide (bp=189° C.), sulfolane (bp=287° C.), and the like. These solvents may be used either individually or as a mixture.

Poor solvents of polyamic acid may be used in combination with the above-described good solvents of polyamic acid in insofar as they do not affect the advantages of the present invention. The presence of the poor solvent makes it possible to control the solubility of the polyimide product in the solvent. In particular, when the polyimide product is of the type that is soluble in the above-described good solvents of polyamic acid, it can be crystallized as fine particles during the thermal imidization by adding a poor solvent of polyamic acid. Such a poor solvent of polyamic acid is preferably a solvent that has a high boiling point and has a polarity that is lower or higher than the polarity of the above-described good solvent (i.e., main solvent) of polyamic acid. Specific examples of the poor solvent of polyamic acid include: hydrocarbon solvents, such as decane, xylene, mesitylene, cyclohexylbenzene, decalin, and the like; ether solvents, such as ethylene glycol dibutyl ether, diethylene glycol dimethyl ether, diethylene glycol diethyl ether, and the like; ketone solvents, such as diisobutyl ketone, cyclohexanone, and the like; and ester solvents, such as 2-ethylhexyl acetate, cyclohexyl acetate, ethylene carbonate, propylene carbonate, and the like.

The total concentration of tetracarboxylic dianhydride and diamine in the polyamic acid solution is preferably in the range of 10 to 30 wt %: If the concentration is too low, the polyaddition reaction does not proceed fast enough, whereas too high a concentration makes the solution too thick to stir. When it is desired to make a polyamic acid solution with a concentration of 10 wt % or less during thermal imidation, such a solution can be obtained by first carrying out the polyaddition reaction at 10 wt % or higher concentration and diluting the solution with a solvent after the reaction is completed. Conversely, the concentration of the polyamic acid solution may be increased to 30 wt % or higher when the solution is not so thick because, for example, of low molecular weight of the polyamic acid.

The molecular weight of polyamic acid in the polyamic acid solution can readily be controlled by increasing the amount of one of tetracarboxylic dianhydride and diamine so that the molar ratio of tetracarboxylic dianhydride to diamine deviates from 1:1. In theory, the molecular weight of the resulting polyamic acid becomes the largest when the molar ratio is 1:1 (equimolar amounts). In general, polyamic acid solutions having the same viscosity can be obtained in a highly reproducible manner by using 0.995 to 0.98 molar equivalents of one of tetracarboxylic dianhydride and diamine with respect to 1 molar equivalent of the other. In doing so, the purity of tetracarboxylic dianhydride and diamine is considered. The resulting polyamic acid obtained in this manner has a number average molecular weight of several million to several hundred million.

While either one of tetracarboxylic dianhydride and diamine may be used in a larger molar amount than the other, the resulting polyamic acid solution tends to become more stable when tetracarboxylic dianhydride is used in a greater molar amount.

When it is desired to adjust the molecular weight of polyamic acid in the polyamic acid solution to a low range of several thousands (oligomer level) and to a relatively low range of several tens of thousands, one of tetracarboxylic dianhydride and diamine is used in 0.98 to 0.9 molar equivalents for each one molar equivalent of the other. In such a case, a monofunctional acid anhydride or a monoamine may be added as an end-capping agent to cap the ends of the polymer molecules and to thereby stabilize the molecular structure. Compounds having other functional groups such as double bonds may be used as the end-capping agent to introduce polymerizable groups at the ends of polyamic acid molecules.

Specific examples of tetracarboxylic dianhydride, one of the two starting materials to make the polyamic acid solution, include pyromellitic dianhydride, 3,3′,4,4′-benzophenonetetracarboxylic dianhydride, 2,3,3′,4′-biphenyltetracarboxylic dianhydride, 3,3′,4,4′-biphenyltetracarboxylic dianhydride, 4,4′-oxydiphthalic dianhydride, 4,4′-(hexafluoroisopropylidene)diphthalic dianhydride, 1,2,4,5-cyclohexanetetracarboxylic dianhydride, 1,2,3,4-cyclobutanetetracarboxylic dianhydride, and the like. These tetracarboxylic dianhydrides may be used either individually or as a mixture of two or more.

Specific examples of diamine, the other of the two starting materials to make the polyamic acid solution, include paraphenylenediamine, metaphenylenediamine, 4,4′-diaminodiphenylether, 4,4′-diamino-2,2′-bis(trifluoromethyl)biphenyl, 2,2′-bis[4-(4-aminophenoxy)phenyl]propane, 2,2′-bis[4-(4-aminophenoxy)phenyl]hexafluoropropane, bis[4-(4-aminophenoxy)phenyl]sulfone, 4,4′-diaminodiphenylsulfone, and aliphatic amines, such as trans-1,4-cyclohexanediamine, 4,4′-methylenebis(cyclohexylamine), and the like. These diamines may be used either individually or as a mixture of two or more.

We now describe the thermal imidization process of the above-described polyamic acid solution.

According to the present invention, the polyamic acid solution with a desired concentration is placed in a glass or stainless-steel container equipped with a stirrer, inert gas inlet, cooler, thermometer, and heater. The polyamic acid solution is then heated under a stream of inert gas while irradiated with ultrasound to be subjected to the thermal imidization process. This gives polyimide fine particles as a precipitate. When the thermal imidization is carried out in the above-described solvent without using any catalysts, the heating is preferably performed at 150° C. to 300° C., more preferably at 180° C. to 220° C., although the temperature may vary depending on the type of polyamic acid used. If the temperature is too low, then imidization proceeds slowly and the effect of hydrolysis and other side reactions becomes significant, resulting in a failure to obtain polyimide particles effectively. If the temperature is too high, then the imidization proceeds faster than is required, with no particular advantages. In addition to this, there are not adequate solvents. The solution may be heated at any rate but preferably at as fast a rate as possible. It is preferred that the solution is stirred by a stirrer during the heating process.

The ultrasound irradiation in the present invention gives two kind of effects. One effect is to make the crystallized polyimide particles finer. The pressure wave generated in the solution by the action of a vibrator, such as probe, causes rapid formation and implosion of small air bubbles in the solution, a phenomenon known as cavitation. This causes a strong shear force applied to the polyimide as it crystallizes. As a result, the aggregation and alignment of the polyimide platelets are prevented. The other effect is to maintain steady boiling of the entire solution. Specifically, the formation of small bubbles triggers the boiling of the solvent when the solution is near its boiling point. The small bubbles also help maintain steady boiling of the solution. The steady boiling of the solution serves to keep the reaction system stirred, prevent precipitation and aggregation of polyimide particles, and eliminate the produced water from the reaction system.

A commercially available ultrasound generator may be used to irradiate ultrasound. There are two types of commonly used ultrasound generators: One is generally known as “ultrasound cleaner” and irradiates ultrasound from outside of an object and the other is generally known as “ultrasound homogenizer” and irradiates ultrasound from inside of an object. Either type can be used in the present invention. Regardless of its type, the ultrasound generator must be modified so that it can operate at high temperatures. Since most commercially available instruments are intended for use at temperatures of 100° C. or below, a heat insulator or a cooler must be arranged between the vibrator and the main unit of the ultrasound generator to avoid overheating of the generator during the high temperature treatment of polyimide, which, according to the present invention, is often carried out at 150° C. or higher temperatures, as described later.

Ultrasound homogenizers are more suitable for the purpose of the present invention because these instruments can focus the energy of ultrasound at a single point and can thus more effectively prevent aggregation and alignment of the crystallized polyimide particles. A ultrasound homogenizers typically consists of a power supply unit, a converter for converting the electrical power into mechanical vibration and a probe for transferring the mechanical energy to a medium. A power supply unit that can provide a power of several hundred watts is sufficient for use in the present invention when the volume of the solution to be treated is less than 1 L. The required power may vary depending on the volume of the solution. The power supply unit preferably generates power at a frequency of about 20 to about 40 kHz. A thinner prove can achieve high energy level but can irradiate only a small area, so that it takes longer to treat the entire solution. Conversely, a thicker prove, despite the low energy level it can achieve, can irradiate a wide area, taking less time to treat the entire solution. In practice, the size of the ultrasound probe is selected based on the rate of the polyimide crystallization. The above-described cooler can simply be arranged in the upper area of the converter or probe that is not immersed in the solution.

A reactor in which to carry out the thermal imidization process may be a common reactor equipped with the above-described ultrasound generator, an inert gas passage, a cooling tube, a stirrer, a heater, and a thermometer.

Unlike common reactors in which both inlet and outlet for inert gas are arranged on the outside of the cooling tube, the inert gas passage of the imidization reactor for use in the present invention is preferably constructed with the inlet of inert gas arranged inside the reactor and the outlet on the outside of the cooling tube. This construction establishes the flow of inert gas from the inside of the reactor, through the cooling tube, to the outside of the reactor. Not only does this construction prevent oxidation and other unwanted side reactions of the reaction product by blocking oxygen, but it also helps eliminate water in the form of water vapor that is carried by the inert gas flow to the outside of the reaction system.

The cooling tube of the imidization reactor is preferably constructed so that the produced water is carried by inert gas out of the system without condensing within the tube. It is thus preferred to set the temperature of the cooling tube at room temperature or above, or if necessary, at 100° C., the boiling point of water, or higher temperatures. The stirrer of the imidization reactor may be any stirrer that can slowly stir the reaction mixture. The solution needs to be stirred during the initial stage of the process in which the polyamic acid solution is heated from room temperature, at which it is relatively thick, to near the boiling point of the solvent. As the solution is heated above 100° C., the polyamic acid becomes less viscous and is ready to be irradiated with ultrasound. The agitating effect of ultrasound is insufficient near this temperature, however. As the temperature of the solution rises near the boiling point of the solvent, the solvent, with the help of the ultrasound, begins to vaporize, vigorously forming numerous small bubbles in the vicinity of the vibrator. Once the steady boiling is established and effective stirring of the solvent is ensured, no further stirring by the stirrer is needed. Therefore, irradiation of ultrasound is preferably started when the temperature of the polyamic acid solution reaches near 100° C. In this manner, the energy of the irradiated ultrasound is effectively transferred to the polyamic acid solution.

Polyimide fine particles begin to crystallize several to several ten minutes after the steady boiling is achieved. The crystallization substantially finishes within several to several ten minutes. Whether the reaction has come to an end or not can be determined by observation or, more preferably, by the yield of the resulting polyimide fine particles. The reaction generally comes to an end within one to two hours after the solution has reached the predetermined thermal imidization temperature. Upon completion of the reaction, the solution is cooled and filtered to obtain fine particles of polyimide as a powder.

The polyimide fine particles crystallized from the polyamic acid solution during the thermal imidization process are not completely imidized: Their imidization ratio is within the range of about 50 to about 98%. The polyimide fine particles with such an imidization ratio are acceptable in some applications, but other applications require substantially complete imidization. For applications that require high imidization ratio, the polyimide fine particles obtained by the process of the present invention are reheated at a temperature of 280° C. to 400° C. for about several minutes to one hour in an inert gas atmosphere to increase the imidization ratio.

The solvent that can be used to dilute the polyamic acid solution may be the same solvent as that used to prepare polyamic acid. Other solvents, such as glycols, cellosolves, carbitols, and diacetone alcohols (such as 1-hexanol, cyclohexanol, and ethyleneglycol having functional groups) may also be used since the polyamic acid has already been synthesized.

The concentration of polyamic acid in the polyamic acid solution used in the thermal imidization process is preferably in the range of 1 wt % to 30 wt %. If the concentration is too low, then the hydrolysis and other unwanted side reactions may dominate the thermal imidization. If the concentration is too high, then the solution becomes too thick to handle. When the molecular weight of the polyamic acid is sufficiently low, even the polyamic solution with a 30 wt % or higher polyamic acid concentration does not become excessively thick and can be handled easily. Economically speaking, the concentration of the polyamic acid solution is preferably as high as possible since the concentration does not significantly affect the shape of the resulting polyimide fine particles. The concentration, however, is generally in the range of about 5 to 20 wt % to ensure that the solution can readily be handled.

The properties of the polyimide particles obtained in the above-described manner largely depend on a particular combination of tetracarboxylic dianhydride and diamine. When the polyimide fine particles are required to have high-heat resistance and high elasticity, a combination of an aromatic tetracarboxylic dianhydride and an aromatic diamine, each having a rigid structure, is preferably used. When the polyimide fine particles are required to have thermoplasticity and solubility in solvents, a combination of an aromatic tetracarboxylic dianhydride and an aromatic diamine that have their benzene rings linked via an ether linkage or a sulfoxide linkage is preferably used. Tetracarboxylic dianhydrides and diamines in which fluorine groups or fluorinated methyl groups have been partially introduced exhibit a high solubility in solvents and are also preferably used. When highly transparent fine particles are desired, aliphatic materials are preferably used.

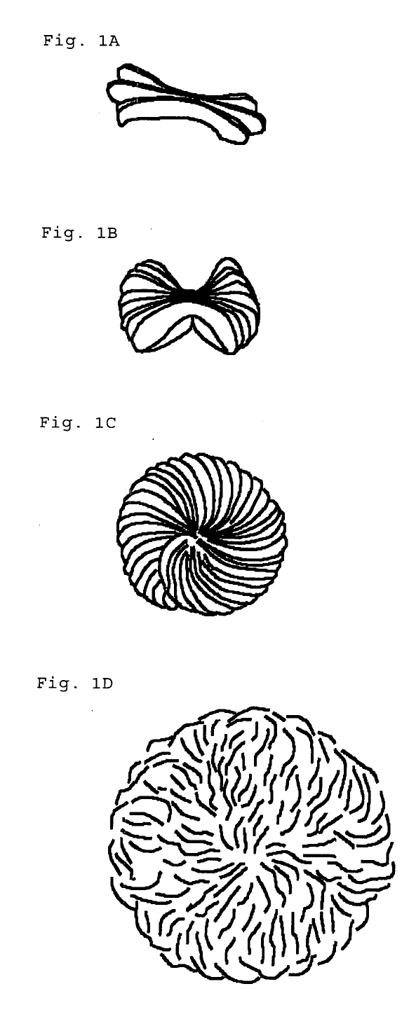

The size and shape of the resulting polyimide fine particles may vary significantly depending, for example, on a particular combination of the materials. Though the underlying mechanism is unclear, it is believed that numerous polyimide platelets that crystallize during the initial stage of the thermal imidization aggregate or align to each other to form a unique shape. The platelets that initially crystallize are planar or rod-shaped platelets that are about 0.1 μm thick and have a width/length of about 0.3 to about 3 μm. Several to several hundreds of such platelets aggregate or align in a regular arrangement, forming a rod-shaped particle (FIG. 1A), a symmetric fan-shaped particle (FIG. 1B), a planar circular particle (FIG. 1C) or a globular particle (FIG. 1D).

In the absence of ultrasound irradiation, the platelets are more likely to aggregate or align to one another, forming larger particles (FIG. 1D). In comparison, when ultrasound is irradiated onto the particles as in the present invention, the oscillation energy of ultrasound acts to prevent the polyimide particles from aggregating or aligning to one another, inhibiting the growth of the particles. This results in the formation of small particles.

The thermal imidization in the production process of the present invention is carried out at a relatively high temperature and therefore does not require dehydrating agents or imidization catalysts such as pyridine. Accordingly, the polyimide particles obtained by the production process of the present invention do not pose the problem of pollution caused by imidization catalysts, nor are they associated with the necessity of removing the catalysts. Thus, the polyimide particles of the present invention can be produced by a simpler process than ever before.

In the production process of the polyimide fine particles of the present invention, particles of a nucleating agent and/or an energy-transferring agent are preferably dispersed in the polyamic acid solution prior to the thermal imidization process. The addition of particles of the nucleating agent makes it possible to control the aggregation sites of polyimide particles and thereby form finer, monodisperse particles by providing nuclei for crystallization of the polyimide particles. The addition of particles of the energy-transferring agent allows effective transfer of ultrasound energy to the polyimide. Furthermore, a dispersant may be added to the polyamic acid solution to prevent aggregation or alignment of the polyimide platelets.

Preferred particles of nucleating agent include heat-resistant polymer fine particles that have high compatibility with the polyimide platelets. Of different polymer fine particles, polyimide fine particles, formed of the same material, are particularly preferred. Preferred particles of energy-transferring agent include particles that are sized several microns or larger and have a relatively high elasticity modulus. Of different types of such particles, metal oxide particles such as silica or alumina particles and metal particles such as nickel flakes are particularly preferred. A preferred dispersant is submicron-sized ultrafine particles having a surface charge that causes electromagnetic attraction that allows the particles to attach to the surface of the polyimide platelets. Of different dispersant particles, active carbon and Aerosil are particularly preferred.

The polyimide particles crystallized in the liquid medium can be separated from the liquid medium by common separation techniques, such as fractional filtration, centrifugation, decantation, and the like. To remove the high bp solvent used and unreacted products, the polyimide fine particles are washed with a solvent such as water, acetone, or ethanol and are then dried. While the dried polyimide fine particles form a pancake-like structure, the individual particles in the structure are not fused; rather, they are weakly aggregated and can be pulverized by a conventional simple pulverization technique.

### EXAMPLES

The present invention will now be described in detail with reference to examples.

### Reference Example 1

### Preparation of Polyamic Acid Solution

Paraphenylenediamine (8.1 g, 749 mmol) was dissolved in 270 g N-methylpyrrolidone in a 450 mL glass vessel. To this solution, 3,3′,4,4′-biphenyltetracarboxylic dianhydride (22.39 g, 75.8 mmol) was added and the vessel was immediately sealed. The reaction vessel was then rotated on a jar mill to stir the reaction mixture. The polyaddition reaction proceeded as tetracarboxylic acid dissolved. The viscosity of the reaction mixture became the highest after several hours and was observed to decrease afterwards. A stable solution of polyamic acid (10.1% solid content) resulted after 12 hours and was assigned “polyamic acid solution BPD.”

### Reference Example 2

### Preparation of Polyamic Acid Solution

Paraphenylenediamine (9.86 g, 91.2 mmol) was reacted with pyromellitic dianhydride (20.14 g, 92.3 mmol) in the same manner as in Reference Example 1 to give a polyamic acid solution “PMD” (10% solid content).

### Reference Example 3

### Preparation of Polyamic Acid Solution Paraphenylenediamine (7.4 g, 68.4 mmol) was reacted with 3,3′,4,4′-benzophenonetetracarboxylic dianhydride (22.6 g, 70.1 mmol) in the same manner as in Reference Example 1 to give a polyamic acid solution “BTD” (10% solid content).

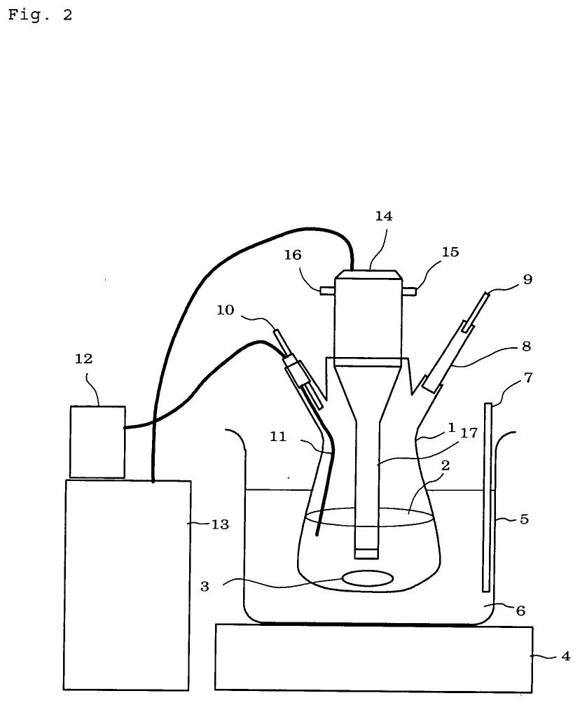

With reference to FIG. 2, which schematically shows the reactor used in Examples that follow, reference numeral 1 denotes a glass reaction vessel, 2 denotes a reaction mixture, 3 denotes a stirrer, 4 denotes a magnetic stirrer, 5 denotes an oil bath, 6 denotes oil, 7 denotes a thermometer, 8 denotes a cooling tube, 9 denotes a nitrogen outlet, 10 denotes a nitrogen inlet, 11 denotes a thermocouple, 12 denotes a thermometer, 13 denotes a ultrasound transmitter main unit, 14 denotes a converter, 15 denotes a cooling air inlet, 16 denotes a cooling air outlet, and 17 denotes a probe.

### Example 1

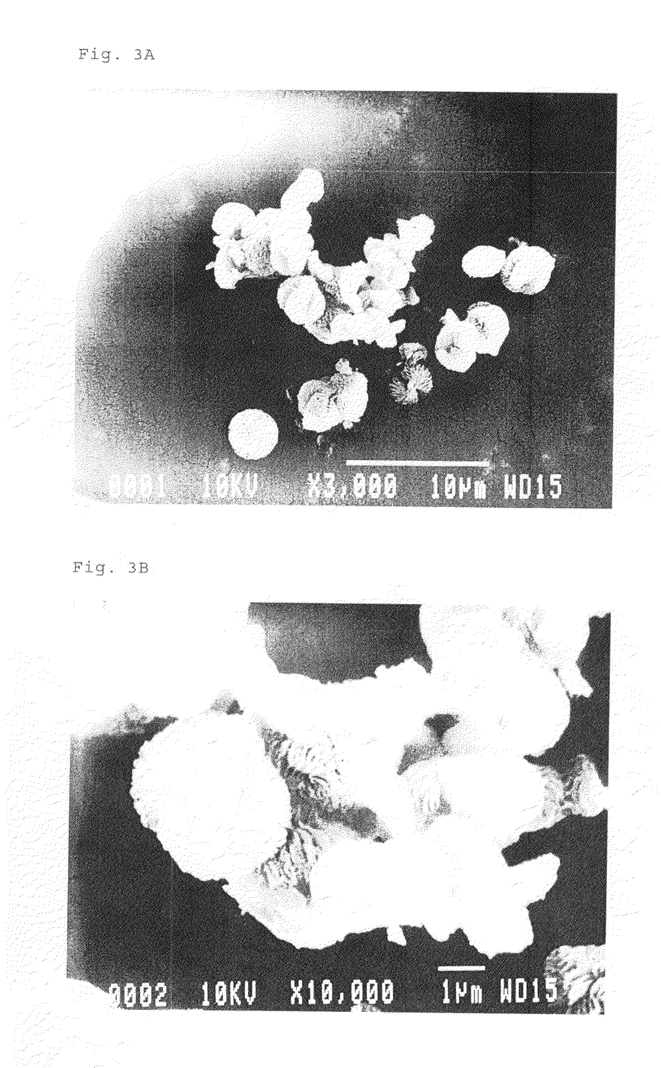

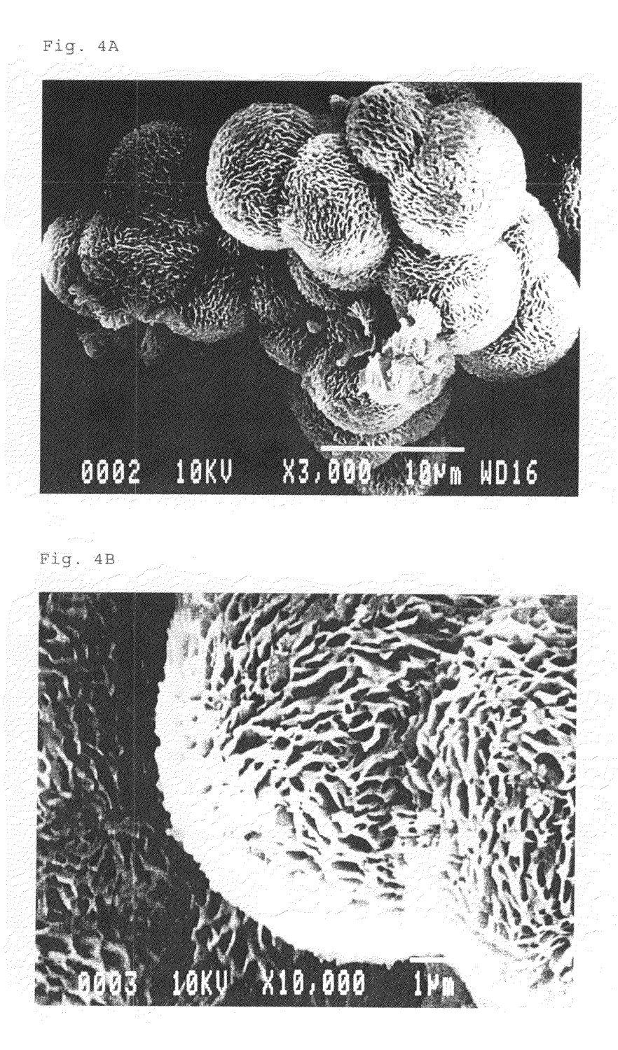

70 g of the polyamic acid solution BPD were placed in a 300 mL glass reaction vessel as shown in FIG. 2. The reaction vessel was immersed in an oil bath that was heated to a temperature slightly above the reaction initiation temperature. Ultrasound irradiation was started when the reaction mixture reached 130° C. (reaction starting point). Starting at this point, oil bath heating was resumed: The oil bath was heated to 210° C. after 25 minutes and was kept at 210° C. 20 minutes after the reaction was started, the reaction mixture cooled to 200° C., at which point the solvent started to boil and a vigorous convection flow was observed. At this point, polyimide began to crystallize and the reaction mixture turned cloudy after 25 minutes. The reaction was continued for a total of 90 minutes without any change in the appearance of the reaction mixture. Subsequently, the reaction vessel was pulled out of the oil bath and was allowed to cool. Using a vacuum filter, the cooled reaction mixture was filtered to separate crystallized polyimide fine particles, which in turn were washed with acetone and filtered again. The resulting polyimide fine particles were dried in an oven at 60° C. for 12 hours. The dried polyimide fine particles were weighed to determine the yield, and it was 93.4%. Electron microscopy of the fine particles revealed that the fine particles were mainly composed of globular particles and planar circular particles sized about 3.3 μm. These particles consisted of numerous radially arranged platelets. Grooves were seen on the surface of the particles between the platelets (FIG. 3A (×3,000), FIG. 3B (×10,000)).

### Comparative Example 1

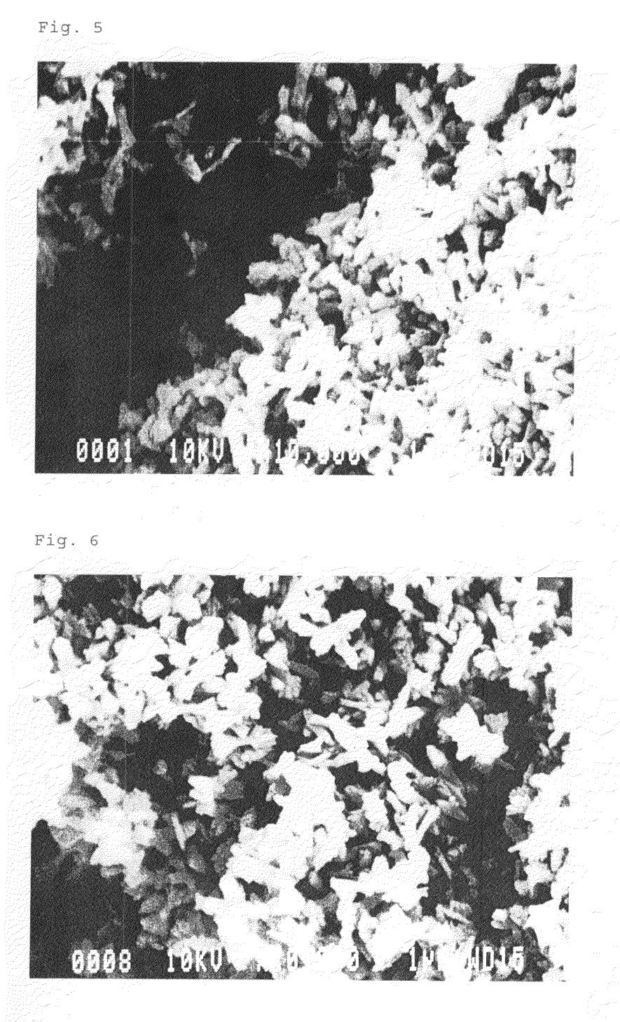

Polyimide fine particles were prepared in the same manner as in Example 1, except that the solution was not irradiated with ultrasound and a motor-driven stirring vane was used to stir the reaction mixture during the reaction. The yield was determined to be 90.1%. Electron microscopy revealed that the particles were large globular particles sized about 10 μm and several tens of them were fused to form lumps (FIG. 4A (×3,000), FIG. 4B (×10,000)).

A comparison of Example 1 and Comparative Example 1 proved that the ultrasound irradiation resulted in polyimide fine particles approximately one-third in size and prevented the particles from fusing with each other.

### Examples 2 through 4

Polyimide fine particles were prepared in the same manner as in Example 1, except that the polyamic acid solution BPD was diluted with N-methylpyrrolidone to concentrations of 8 wt % (Example 2), 6 wt % (Example 3), and 4 wt % (Example 4).

The time that it took before each reaction mixture started to turn cloudy became longer and the yield of the polyimide particles decreased with decreasing concentrations of the polyamic acid. The solution with 4′ polyamic acid (Example 4) took 25 minutes before it started to turn cloudy. This solution gave an 81% yield. The globular particles decreased and, instead, planar circular particles and symmetric fan-shaped particles increased with decreasing concentrations of the polyamic acid. Most of the particles were symmetric fan-shaped particles at 6% or lower concentrations of polyamic acid. The particle size did not vary significantly by concentration.

### Comparative Examples 2 through 4

Polyimide fine particles were prepared in the same manner as in Comparative Example 1, except that the polyamic acid solution BPD was diluted with N-methylpyrrolidone to concentrations of 8 wt % (Comparative Example 2), 6 wt % (Comparative Example 3), and 4 wt % (Comparative Example 4).

As in Examples 2 through 4, the time that it took before each reaction mixture started to turn cloudy became longer and the yield of the polyimide particles decreased with decreasing concentrations of the polyamic acid. All of the resulting polyimide particles were large globular particles irrespective of the concentration of the polyamic acid. As in Comparative Example 1, ten and several of the particles were fused to form lumps. The particle size slightly increased with decreasing concentrations of the polyamic acid: The size was 13 μm at a concentration of 4%.

The results of Examples 2 through 4 and Comparative Examples 2 through 4 indicate that, irrespective of the concentration of the polyamic acid, the ultrasound irradiation resulted in a significant reduction in particle size and prevented the particles from fusing with each other. These results are summarized in Tables 1 and 2 (Polyamic acid concentrations and the shape of polyimide fine particles under ultrasound irradiation).

TABLE 1

| | | | | Time at | | | |
|---|---|---|---|---|---|---|---|
| | | | | which | | | |
| | | | | solution | Total | | |
| | | | Solid | tuned | reaction | Corrected | |
| | BPD | Additional | component | cloudy | time | amount | Yield |
| | (g) | NMP (g) | (%) | (min) | (min) | (g) | (%) |
| Ex. 1 | 70 | 0 | 10.1 | 20 | 90 | 6.60 | 93.4 |
| Ex. 2 | 60 | 15 | 8.08 | 21 | 90 | 5.63 | 92.9 |
| Ex. 3 | 45 | 32 | 5.90 | 21 | 90 | 4.16 | 91.5 |
| Ex. 4 | 30 | 45 | 4.06 | 25 | 90 | 2.45 | 80.9 |
| Com | 70 | 0 | 10.1 | 20 | 90 | 6.37 | 90.1 |
| Ex. 1 | | | | | | | |
| Com | 60 | 15 | 8.08 | 21 | 90 | 5.10 | 84.2 |
| Ex. 2 | | | | | | | |
| Com | 45 | 32 | 6.06 | 24 | 90 | 3.78 | 83.2 |
| Ex. 3 | | | | | | | |
| Com | 30 | 45 | 4.06 | 28 | 90 | 2.51 | 82.8 |
| Ex. 4 | | | | | | | |

TABLE 2

| | Polyimide fine particles | | |
|---|---|---|---|
| | Particle | | Microscopic |
| | size (μm) | Shape | structure |
| Ex. 1 | 3.3 | Mostly globular particles | Radially arranged |
| | 3.3 | with a small amount of | platelets |
| | | planar circular particles | |
| Ex. 2 | 3.3 | Planar circular particles | Radially arranged |
| | 2.5 × 4 | and symmetric fan-shaped | platelets |
| | | particles | |
| Ex. 3 | 2.5 × 4 | Mostly symmetric fan- | Radially arranged |
| | | shaped particles | platelets |
| Ex. 4 | 2.5 × 4 | Mostly symmetric fan- | Radially arranged |
| | | shaped particles | platelets |
| Com Ex. 1 | 10 | Fused globular particles | Radially arranged |
| | | | platelets |
| Com Ex. 2 | 10 | Fused globular particles | Radially arranged |
| | | | platelets |
| Com Ex. 3 | 11 | Fused globular particles | Radially arranged |
| | | | platelets |
| Com Ex. 4 | 13 | Fused globular particles | Radially arranged |
| | | | platelets |

### Example 5

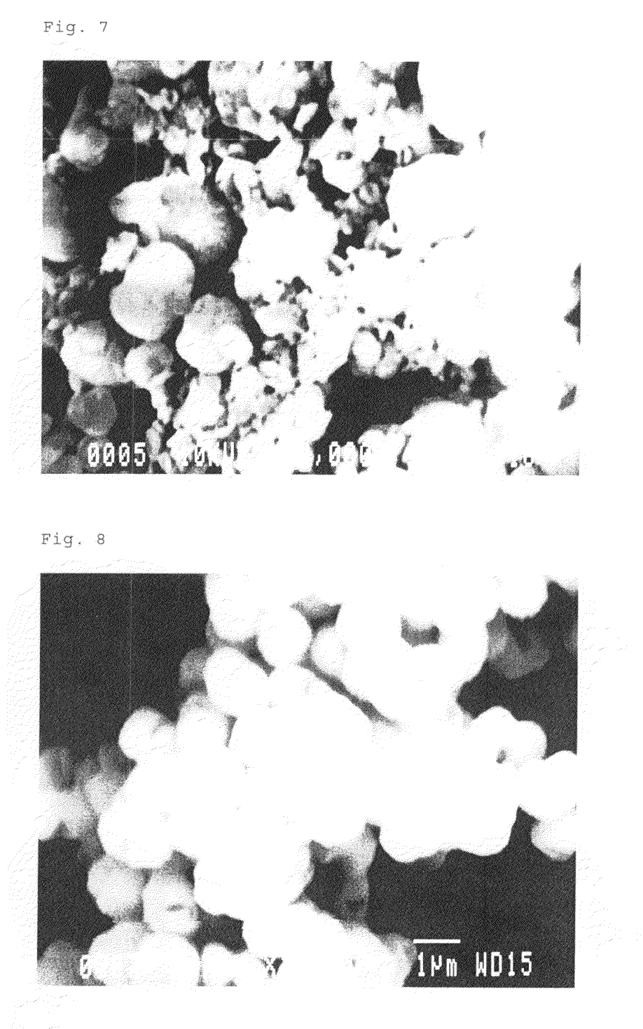

The polyamic acid solution (PMD) prepared from pyromellitic dianhydride and paraphenylenediamine was subjected to a thermal imidization process as in Example 1. The solution was heated from 130° C. to 200° C. over a time period of 34 minutes and was kept at 200° C. The resulting polyimide fine particles were rod-shaped fine particles sized about 0.3×1.0 μm (FIG. 5 (×10,000)). Some of the particles had two or three thick forked ends, assuming an hourglass-shape. As opposed to the initially planned reaction time of 90 minutes, the reaction was terminated after 42 minutes since the reaction mixture had lost its fluidity and the ultrasonic unit had been overloaded with the mixture that could no longer be stirred.

### Comparative Example 5

Polyimide fine particles were prepared in the same manner as in Example 5, except that the polyamic acid solution was not irradiated with ultrasound and the reaction was carried out over a total reaction time of 90 minutes. Electron microscopy revealed that the resultant particles were rod-shaped particles sized about 0.5×1.5 μm, which was slightly larger than the particles obtained in Example 5 (FIG. 6 (×10,000)). Some of the particles had two or six forked ends, assuming an hourglass-shape that was thicker than the rod-shaped particles of Example 5. The hourglass-shaped particles were present in a larger proportion than in Example 5.

The results of Example 5 and Comparative Example 5 demonstrate that although the polyamic acid solution (PMD) prepared from pyromellitic dianhydride and paraphenylenediamine can inherently give polyimide fine particles with a relatively small particle size when subjected to the thermal imidization process, the particles can be made even finer by ultrasound irradiation.

### Example 6

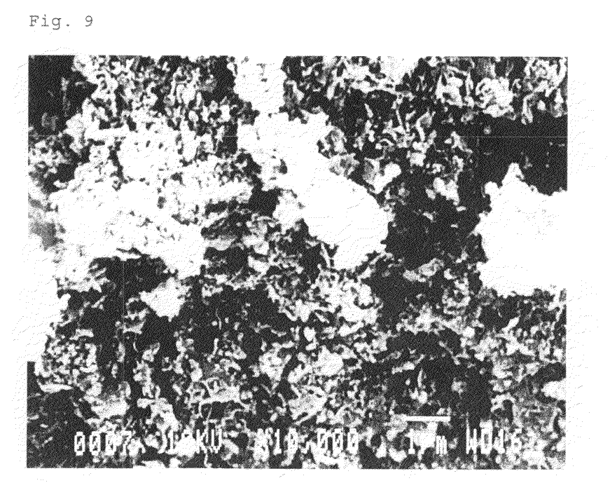

The polyamic acid solution (BTD) prepared from 3,3′,4,4′-benzophenonetetracarboxylic dianhydride and paraphenylenediamine was subjected to a thermal imidization process as in Example 5. The corresponding polyimide fine particles were obtained at a high yield. The particles were obtained as a mixture of platelets sized about 0.2 (thickness)×0.7 μm and cocoon-shaped particles that were sized about 1.2×1.6 μm and have a waist (FIG. 7 (×10,000)). The reaction was carried out over a total reaction time of 90 minutes.

### Comparative Example 6

Polyimide fine particles were prepared in the same manner as in Example 6, except that the polyamic acid solution was not irradiated with ultrasound. The resulting particles consisted solely of 1.2×1.6 μm cocoon-shaped particles having a waist (FIG. 8, (×10,000)). This observation suggests the following mechanism: When the polyamic acid is BTD, platelets are first generated and they then aggregate to form cocoon-shaped particles. When irradiated with ultrasound, however, the platelets do not effectively grow into cocoon-shaped particles and some of them are left unincorporated into particles. The ultrasound irradiation thus made it possible to make finer particles. These results are shown in Tables 3 and 4 (Types of polyamic acid and shape of polyimide fine particles formed under ultrasound irradiation).

TABLE 3

| | | | | Solution | | | | |
|---|---|---|---|---|---|---|---|---|
| | | | | tuned | | Total | | |
| | | | Solid | cloudy | | reaction | Corrected | |
| | PMD or | Additional | component | Time | Temp | time | amount | Yield |
| | BTD/(g) | NMP (g) | (%) | (min) | (° C.) | (min) | (g) | (%) |
| Ex. 5 | PMD/60 | 15 | 8.00 | 20 | 184 | 42 | 5.60 | 94.3 |
| Ex. 6 | BTD/60 | 15 | 8.00 | 20 | 186 | 90 | 5.37 | 89.5 |
| Com | PMD/60 | 15 | 8.00 | 21 | 181 | 90 | 5.73 | 96.5 |
| Ex. 5 | | | | | | | | |
| Com | BTD/60 | 15 | 8.00 | 21 | 192 | 90 | 5.10 | 85.0 |
| Ex. 6 | | | | | | | | |

TABLE 4

| | Polyimide fine particles | | |
|---|---|---|---|
| | Particle | | Microscopic |
| | size (μm) | Shape | structure |
| Ex. 5 | 0.3 × 1.0 | Rod-shaped particles | Containing forked |
| | | | hourglass-shaped |
| | | | particles |
| Ex. 6 | 0.2 × 0.7 | Irregular platelet | None |
| | | particles | |
| | 1.2 × 1.6 | Cocoon-shaped | |
| | | particles with a waist | |
| Com Ex. 5 | 0.5 × 1.5 | Rod-shaped particles | Containing forked |
| | | | hourglass-shaped |
| | | | particles |
| Com Ex. 6 | 1.2 × 1.6 | Cocoon-shaped | None |
| | | particles with a waist | |

### Example 7

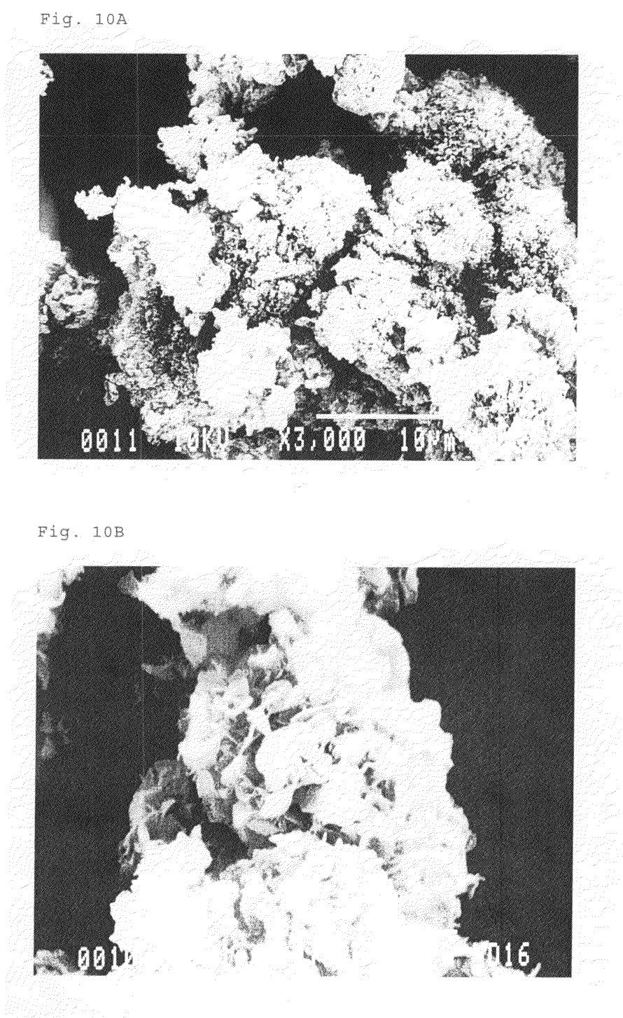

18 g of N-methylpyrrolidone were added to 70 g of the polyamic acid solution (BPD) to make an 8 wt % solution. To this solution, 2 g of ketchen black, or carbon fine powder, were added and the mixture was thoroughly stirred until uniform. The resulting mixture was subjected to a thermal imidization process using the same experimental setup as in Example 1. The reaction mixture was heated from 180° C. to 200° C. over a time period of 18 minutes and was kept at 200° C. Polyimide fine particles began to crystallize 15 minutes after the reaction was started. 8.89 g of polyimide fine particles were obtained. Subtracting the amount of ketchen black from the amount of polyimide fine particles left 6.89 g, which was equivalent to a 97.5% yield. Electron microscopy revealed that the resulting polyimide particles were platelets having a thickness of about 0.1 μm and a diameter of about 1 μm, the platelets seen uniformly mixed with ketchen black particles (FIG. 9 (×10,000)).

### Comparative Example 7

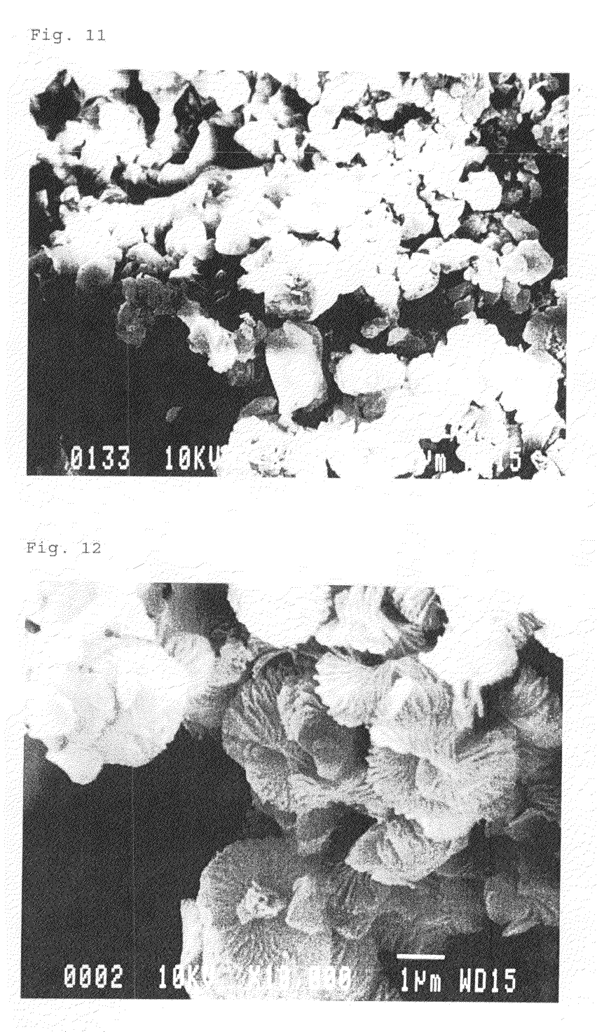

Polyimide particles were prepared in the same manner as in Example 7, except that the polyamic acid solution was not irradiated with ultrasound. The resulting particles were large distorted particles sized 10 to 13 μm. About ten to twenty particles were fused to form lumps. Unlike the radial arrangement observed in Comparative Example 1, the platelets were fused in a rose flower-like arrangement (FIG. 10A (×3,000), FIG. 10B (×10,000)).

Though the underlying mechanism for this arrangement of the polyimide particles is not fully understood, it is believed to be as follows: Submicron particles such as ketchen black particles tend to adhere to other objects because of electric force. Thus, ketchen black particles attach to the surface of the polyimide platelets that crystallize as the thermal imidization proceeds. This prevents the platelets from assembling into the radial arrangement, but rather causes them to aggregate into the rose flower-like arrangement. However, this effect is not significant enough to prevent the formation of globular particles since the platelets were still capable of forming large particles 1.0 to 13 μm in size though the particles were distorted. In comparison, the platelets can no longer aggregate with each other and can thus hardly form large particles in Example 7. This is thought to be as a result of the ultrasound irradiation combined with the disruptive effect of ketchen black.

### Example 8

18 g of N-methylpyrrolidone were added to 70 g of the polyamic acid solution (BPD) to make an 8 wt % solution. To this solution, 7 g of shirasu soil, crushed volcanic glass (10 μm or less in size), were added and dispersed uniformly. The resulting mixture was subjected to a thermal imidization process as in Example 1. Specifically, the reaction mixture was heated from 100° C. to 200° C. over a time period of 20 minutes and was kept at 200° C. The polyimide particles were obtained in an 88% yield (without shirasu component). The resulting particles were 1 to 3 μm particles with irregular shapes (FIG. 11 (×6,000)). These irregular particles were even finer than the particles obtained in Example 2. This is believed to be because the shirasu particles added served as a medium that effectively transferred the energy of the ultrasound to the crystallized polyimide.

### Example 9

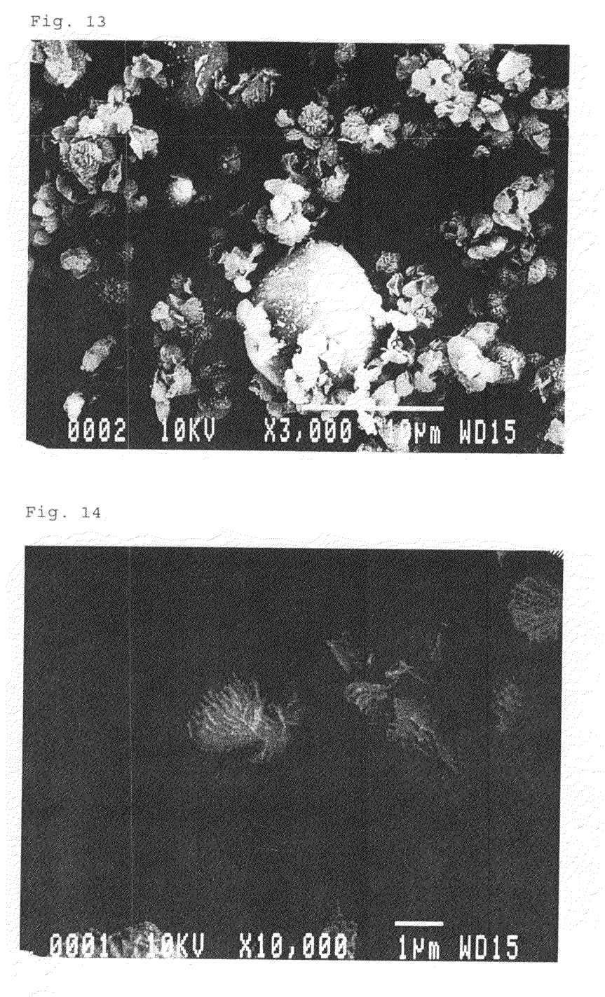

Polyimide particles were prepared in the same manner as in Example 8, except that the amount of the shirasu soil added was 1 g. The particles were obtained as a mixture of 2.5×3.5 μm planar circular particles and symmetric fan-shaped particles (FIG. 12 (×10,000)). No significant changes were observed except that the polyimide particles were slightly smaller than those obtained in Example 2. This suggests that 1 g or more shirasu soil needs to be added to provide the desired effect.

### Example 10

Polyimide particles were prepared in substantially the same manner as in Example 8, except that 6 g of globular alumina particles 5 to 10 μm in size were added in place of the shirasu soil. The resulting particles consisted mainly of 2×3 μm symmetric fan-shaped particles, with some being globular particles sized about 3 μm (FIG. 13 (×10,000)). The addition of the alumina particles proved effective to some extent, though not as effective as the shirasu soil added in Example 8.

### Example 11

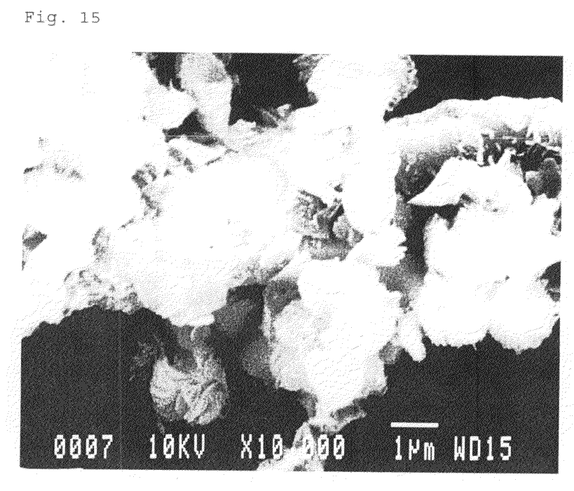

Polyimide particles were prepared in substantially the same manner as in Example 8, except that 6 g of nickel flake were added in place of the shirasu soil. The particles were obtained as a mixture of 1.5×2.5 μm symmetric fan-shaped particles and 1.0×2.0 μm debris of the former particles (FIG. 14 (×10,000)). The addition of nickel flake enhanced the effect of the ultrasound irradiation.

### Example 12

Polyimide particles were prepared in substantially the same manner as in Example 8, except that 6 g of mica flake were added in place of the shirasu soil. The particles were obtained as a mixture of 1.5×2.5 μm symmetric fan-shaped particles and 1.0×2.0 μm debris of the former particles (FIG. 15 (×10,000)). As with the case of nickel flake, the addition of mica flake enhanced the effect of the ultrasound irradiation.

The results of Examples 8 through 12 demonstrate that while the addition of relatively large particles sized about several to 10 μm to the polyimide fine particles does not interrupt the arrangement of polyimide platelets as in the case of ketchen black in Example 7, these particles serve as a medium to transfer the energy of ultrasound and thereby facilitate formation of finer polyimide particles.

### Example 13

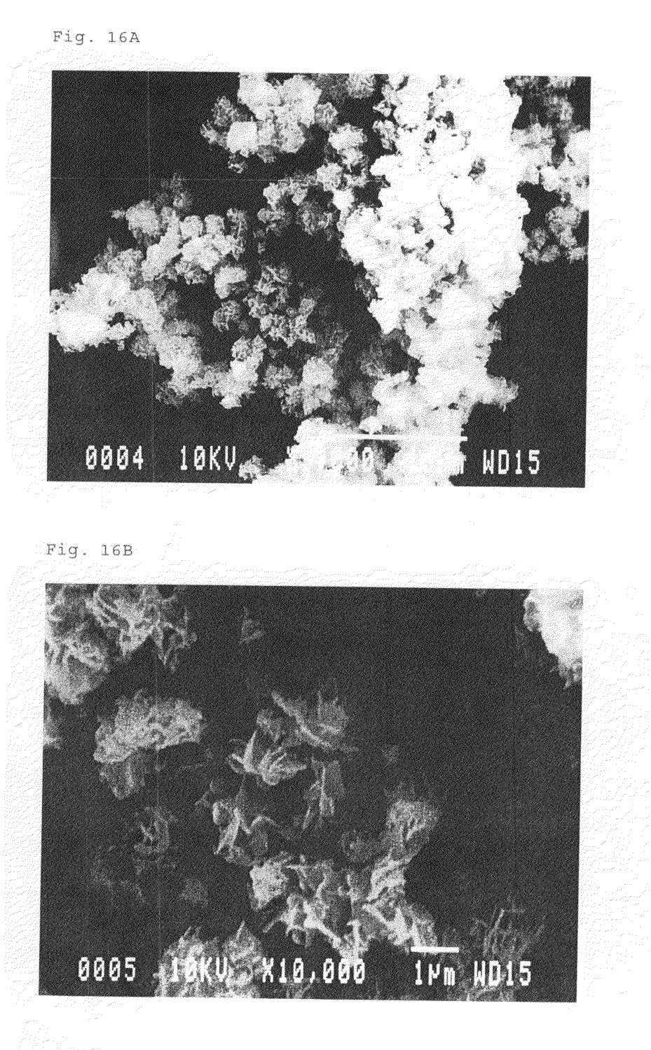

20 g of N-methylpyrrolidone were added to 60 g of the polyamic acid solution (BPD) to make a 7.6 wt % solution. To this solution, 3 g of the polyimide fine particles obtained in Example 5 were added and the mixture was stirred until uniform in a planetary mixer. Subsequently, substantially the same procedure as in Example 8 was followed to give polyimide fine particles. The resulting fine particles were globular particles 1 to 3 μm in size and had a unique shape consisting of several tens of the polyimide platelets aggregated in a rose flower-like arrangement (FIG. 16A (×3,000), FIG. 16B (×10,000)).

Unlike the ketchen black particles added in Example 7 or the minerals and metal particles added in Examples 8 through 12, the addition of the prefabricated polyimide particles in Example 13 causes the crystallized polyimide platelets to aggregate in a characteristic arrangement, forming fine particles with a characteristic shape. The underlying mechanism is considered to be that the added polyimide fine particles serve as nuclei for the crystallization of polyimide and the resulting polyimide platelets aggregate in a unique arrangement. The results of Examples 7 through 13 are collectively shown in Tables 5 and 6.

TABLE 5

| | | | | | | Imidization conditions | | | |
|---|---|---|---|---|---|---|---|---|---|
| | | | | | | | | Time at | |
| | | | | | | | | which | |
| | | | | | | | | solution | Total |
| | | | | | Solid | Starting | Reaction | turned | reaction |
| | BPD | Additional | Additives | | component | temp | temp | cloudy | time |
| | (g) | NMP (g) | wt % | Type | (%) | (° C.) | (° C.) | (min) | (min) |
| Ex. 7 | 70 | 18 | 2 | Ketchen | 8.00 | 180 | 200 | approx. 15 | 90 |
| | | | | black | | | | | |
| Ex. 8 | 70 | 18 | 7 | Shirasu | 8.00 | 100 | 200 | approx. 20 | 90 |
| Ex. 9 | 70 | 18 | 1 | Shirasu | 8.00 | 100 | 200 | approx. 20 | 90 |
| Ex. 10 | 60 | 15 | 6 | Alumina | 8.10 | 133 | 210 | approx. 19 | 90 |
| | | | | particles | | | | | |
| Ex. 11 | 60 | 17 | 6 | Nickel | 7.90 | 132 | 210 | approx. 20 | 90 |
| | | | | flake | | | | | |
| Ex. 12 | 60 | 16 | 6 | Mica flake | 8.00 | 140 | 210 | approx. 20 | 90 |
| Ex. 13 | 45 | 3 | | Polyimide | 7.60 | 130 | 210 | approx. 19 | 62 |
| | | | | particles | | | | | |
| Com Ex. 7 | 70 | 18 | 2 | Ketchen | 8.00 | 180 | 200 | approx. 15 | 90 |
| | | | | black | | | | | |

TABLE 6

| | Collected | | Polyimide fine particles | | | |
|---|---|---|---|---|---|---|
| | amount | Yield | | | | Microscopic |
| | (g) | (%) | Particle size | | Shape | structure |
| Ex. 7 | 8.89 | 97.5 | approx. 1 | μm | Irregular | Uniformly |
| | | | (0.1 | μm thick) | platelets | dispersed with |
| | | | | | | ketchen black |
| Ex. 8 | 13.15 | 88.0 | 1-3 | μm | Irregular | — |
| | | | | | particles | |
| Ex. 9 | 7.85 | 98.0 | 2.5 × 3.5 | μm | Planar circular | Radially |
| | | | (1.5 | μm thick) | particles and | arranged |
| | | | | | symmetric fan- | platelets |
| | | | | | shaped particles | |
| Ex. 10 | 11.30 | 87.3 | 2 × 3 | μm | Mostly symmetric | Platelets in |
| | | | 3 | μm | fan-shaped | arrangement |
| | | | | | particles with a | |
| | | | | | small amount of | |
| | | | | | globular | |
| | | | | | particles | |
| Ex. 11 | 11.2 | 85.7 | 1.5 × 2.5 | μm | Symmetric fan- | Platelets in |
| | | | 1.0 × 2.5 | μm | shaped particles | arrangement |
| | | | | | and their debris | |
| Ex. 12 | 11.10 | 84.0 | 1.5 × 2.5 | μm | Symmetric fan- | Platelets in |
| | | | 1.0 × 2.5 | μm | shaped particles | arrangement |
| | | | | | and their debris | |
| Ex. 13 | 8.88 | 96.9 | 1-3 | μm | Globular | Particles |
| | | | | | particles with | consisting of 10 |
| | | | | | rose flower-like | to 20 platelets |
| | | | | | platelet | aggregated in a |
| | | | | | arrangement | rose flower-like |
| | | | | | | arrangement |
| Com | 8.71 | 94.9 | 10-13 | μm | Distorted | Particles |
| Ex. 7 | | | | | globular | consisting of |
| | | | | | particles | platelets fused |
| | | | | | | in a rose |
| | | | | | | flower-like |
| | | | | | | arrangement |

### INDUSTRIAL APPLICABILITY

The process of the present invention for producing polyimide fine particles involves subjecting a polyamic acid solution to a thermal imidization process while the solution is irradiated with ultrasound. The process thus makes it possible to obtain relatively uniform polyimide fine particles that are not only finer than those obtained by conventional approaches, but also have a narrow size distribution. The polyimide fine particles obtained by the process of the present invention are therefore suitable for use as a material to make polyimide molded articles or as a heat-resistant filler or in other applications.

1. A process for producing polyimide fine particles, comprising the step of subjecting a polyamic acid solution to a thermal imidization process to crystallize polyimide in the form of fine particles, wherein the thermal imidization step comprises heating the polyamic acid solution while the solution is irradiated with ultrasound.

2. The process according to claim 1, wherein the thermal imidization step comprises heating the polyamic acid solution to 180° C. or above.

3. The process according to claim 2, wherein the polyamic acid solution is heated under a stream of nitrogen to a temperature near a boiling point of a solvent used to make the solution.

4. The process according to claim 1, wherein particles of a nucleating agent and/or an energy-transfer agent are dispersed in the polyamic acid solution prior to the thermal imidization step.

5. The process according to claim 4, wherein particles of a polyimide nucleating agent are dispersed in the polyamic acid solution in advance.

6. The process according to claim 1, wherein the polyamic acid solution is obtained by reacting a carboxylic dianhydride with a diamine in a solvent.

7. The process according to claim 2, wherein particles of a nucleating agent and/or an energy-transfer agent are dispersed in the polyamic acid solution prior to the thermal imidization step.

8. The process according to claim 3, wherein particles of a nucleating agent and/or an energy-transfer agent are dispersed in the polyamic acid solution prior to the thermal imidization step.

9. The process according to claim 2, wherein the polyamic acid solution is obtained by reacting a carboxylic dianhydride with a diamine in a solvent.

10. The process according to claim 3, wherein the polyamic acid solution is obtained by reacting a carboxylic dianhydride with a diamine in a solvent.

11. The process according to claim 4, wherein the polyamic acid solution is obtained by reacting a carboxylic dianhydride with a diamine in a solvent.

12. The process according to claim 5, wherein the polyamic acid solution is obtained by reacting a carboxylic dianhydride with a diamine in a solvent.
